(19) United States
(12) Patent Application Publication
(10) Pub. No.: US 2007/0024603 A1
(43) Pub. Date: Feb. 1, 2007

(54) Integrated digital picture viewing device

(76) Inventor: Xiao-Chang Charles Li, Yardley, PA (US)

Correspondence Address: XIAO-CHANG CHARLES LI, 263 ROCK RUN ROAD, YARDLEY, PA, 19067, US

(21) Appl. No.: 11/191,783

(22) Filed: Jul. 28, 2005

(51) Int. Cl. G09G 5/00

(52) U.S. Cl. 345/204

(57) ABSTRACT

A device for digitally generating a plurality of still pictures consist of a bistable reflective full color flat panel display such as an interference modulation flat panel display (IMD), a coated non-glare coating on the viewing side of the display panel, a cartridge shaped CPU, and a cartridge shaped audio/video playback system which are located in the picture frame. The reflective display disclosed in this patent resembles a traditional painting or photograph, and allows better viewability and reduces eye fatigue linked with luminous display device. The reflective flat panel display has bistable characteristics and therefore it consumes extremely low power in a still picture display state, and it is preferably powered by a set of batteries. The device is a structure resembling a framed picture, portrait, or a painting used in a home, hotel, museum, gallery, building corridor, or any people gathering place, and the displayed content can be easily changed digitally.

### BACKGROUND OF THE INVENTION

1. Field of the Invention

The present invention relates to an integrated digital picture viewing device and more particularly relates to a new smart digital picture viewing apparatus for displaying digital still images that maximally resembles a printed or painted picture with a state-of-the-art full color reflective bistable flat-panel display screen, integrated with a digital image and a digital audio message playback system in the form of cartridge and assembled inside the picture frame which is powered preferably by a set of batteries.

2. Description of the Related Art

So far the most widely used electronic image display device is still cathode ray tube display due to its cheap cost and long life time. This bulky display device (such as the one used as TV set and computer monitor) is however being replaced in recent years more and more by slim flat panel displays, such as an active matrix full color liquid crystal display (LCD) flat panel display. The display size of LCD has gradually advanced from initial small size used in personal digital appliance (PDA) such as a mobile phone screen to media size display such as a personal computer monitor, and very recently to big size flat panel display as large area screen TVs (with diagonal size 20-80 inches). Other modern flat panel displays are also emerged in recent years, being small to media flat panel displays of organic-light emitting displays (OLED) with size from 2-40″ and large flat panel displays of plasma display panel (PDP) and light-emitting diode arrays (LED) display panels with size from 36-100 inches. All the mentioned flat-panel displays can vividly display images with full color and are very good for movie picture display, with backlit LCD being the most commonly used due to its slim feature combined with crispy full color display and fine resolution. When properly assembled with a memory peripheral, a moving picture stored in a video memory media such as a disk or a hard disk in a computer, can be displayed as a still picture under a continuous power supply. A few prior arts concerned with still picture display are therefore based on LCD display due to its wide recognized use in the market. Although luminous flat panel display can be used for still picture display, it ultimately causes human eye fatigue and greatly reduces our art appreciation desire. Besides, self-luminous flat panel displays also consume considerable electric energy to deliver continuous light emission, which will restrict their portability as well as their own display lifetime. It is desirable to develop a truly picture viewing device that can overcome the mentioned drawbacks, and resemble as much as normal printed or drawn pictures and paintings. That means a device which does not emit light while displaying and thus consumes zero or very little energy.

Traditionally pictures such as paintings, portraits, photographs, or the like, are printed, painted or drawn on medias like paper, canvas, fabrics etc, and displayed inside a frame in various sites, such as in a home, hotel, museum, gallery or any people gathering place to provide art appreciation and/or memorial enjoyment. These “hard copy” pictures, whatever original drawings or simply copied, are not able to change their displayed contents once drawn or painted. It is desirable to provide a picture viewing device that the displayed picture or information can be changed or replaced digitally according to situational need. With the advancement of digital camera, people tend to use digital camera more and more, and the taken digital photos are either printed or stored and viewed through a computer for appreciation. It is therefore desirable to provide a picture viewing device that any digital pictures taken by a digital camera can be viewed and displayed in a picture viewing device that greatly resembles printed or painted pictures and displayed digitally and controlled digitally, and furthermore it can be hang on the wall in a family house or in a gallery etc. In the prior art, an electronic picture viewing apparatus was disclosed (U.S. Pat. No. 6,535,139) wherein electronic images in a picture frame can be well controlled by a control house in the back of a display screen. This apparatus presents flexibility for controlling image content, but only suitable for self standing on floor, and neither be hung nor lack of a suitable display due to the need for a house with electronic control peripherals. A pocket sized electronic photograph with a LCD screen and electronically programmed device to generate still photograph is disclosed in (U.S. Pat. No. 4,754,271). Similarly in another prior art, a digital image display photo album was disclosed wherein a digital photo can be displayed in a hand-held device which displays digital images stored on an inserted compact disc with the use of a CD player attached (US application US2004/0252594 A1). To provide a picture display with accompanying audio message such that one or more audio messages associated with one picture can be played upon the touching of the pictures or the frame, U.S. Pat. No. 5,504,836 disclosed a picture frame with associated audio message controlled electronically by a micro-processor inside the picture frame. Although all these prior arts mainly deal with picture viewing frame, commercialization of such devices are routinely hampered by either printed pictures or by computer based monitor display appreciation. There is a need for a combination of “printed” picture display with a digitally controlled system so as to allow a picture display looks like “printed” picture, and also allow the picture be digitally controlled and switched originated from a stored media.

In the recent years, active matrix liquid crystal screen has been widely used as a flat-panel display for television, computer monitor, information display panels, many mobile personal digital assistant devices (PDA), and camcorder screen, etc. However, normal active matrix full color LCD display is based on backlit display mechanism, and it displays picture with light emission. Although reflective liquid crystal displays are also disclosed recently with the use of a reflective mirror and color filter (U.S. Pat. No. 6,278,429) and cholesteric LCs (U.S. Pat. No. 6,061,107; U.S. Pat. No. 6,278,429; U.S. Pat. No. 6,864,875), the realization of full color reflective LCD displays are still commercially challenged due to its fundamental operation mechanism that requires the use of a color filter and at least a polarizer, and this low reflectivity eventually limits its usefulness as a smart digital picture viewing application as disclosed in this invention. All other available flat panel displays, such as organic light emitting diode (OLED), plasma display panel (PDP), field emission display (FED), light emitting diode array (LED), thin film electroluminescent display (TFEL), can fulfill full color active display functions, but all shows uncomfortable glare to human eye's appreciation due to their light emission nature. Most of all, the self-luminous feature of these flat-panel displays bring unnatural viewing effect, or “faked” picture viewing appreciation, compared to traditional drawn pictures, portraits or paintings, and therefore are not desired display used in this invention. Besides, self-luminous displays means continuous light emission and power consumption, and this will also brings up drawbacks of one side considerable more power consumption when a display is large area, and on the other side shorter lifetime for the display. By nature, human eyes are results of evolution for light reflection rather than light glare. Therefore, any self-luminous flat panel displays are not desired to be useful for an integrated digital picture viewing device in terms of light glare and considerable power consumption, as well as their drawback to cause eye fatigue.

To make a digital viewing device looks like a “printed or painted” picture for human eye appreciation, a reflective flat panel display without using liquid crystal materials showed dramatic benefits than any other self-luminous displays as disclosed in this invention. A reflective flat panel display with particularly bistable memory feature is mostly desirable because the display holds the image in memory without any applied power while the picture is being displayed. With such a bistable memory reflective display, power is needed only when the picture is changed or updated digitally and power is virtually not necessary while displaying an image. This is a tremendous energy saving and a dramatic improvement on the operating lifetime for a battery and for a picture display device respectively.

### SUMMARY OF THE INVENTION

The present invention has been made in consideration of the disadvantages of prior art picture viewing frames for displaying eye appreciation electronic pictures. It is an object of the present invention to provide a still digital picture viewing apparatus that can display an image similar to a printed or a painted picture, a portrait, or a painting, or a photograph, in a naturally light reflective way so as to allow human eye appreciation, and in a digitally controllable way so as to allow change of picture information according to season, festival nature, cultural situation or guest taste. It is also an object of the present invention to provide a still picture viewing apparatus that can read and display any images taken by a digital camera or a camcorder in art appreciation way or in memorial purpose that the picture can be easily hang on wall in a home, a museum, a gallery, a hotel, or any people gathering places. It is yet another object of this invention that the displayed digital picture can be accompanied or synchronized with an audio message digitally spoken and controlled by an audio media electronics drive or by a programmed audio message recording/playback system inside the frame. It is yet another object of this invention to identify and select a suitable flat panel display and even modified so that it can be best used to present naturally full color and naturally reflective image with high reflectivity and without use of energy when displaying the digital image. The display viewing panel as disclosed in this invention is a full color reflective flat-panel display that is different from the widely used luminous flat panel display devices, like cathode ray tube display (normal TV set display), commercially available flat panel displays such as backlit full color liquid crystal display (LCD), organic light-emitting display (OLED), field emission display (FED), and plasma display panel (PDP) etc. The reflective display in the integrated picture viewing device of this invention means a display that is not self-luminous and the displayed picture is viewed in ambient lit condition mainly by light reflection, making the digital picture viewed more like a natural hard copy picture on paper or on canvas media with “printed or painted” viewing quality. The reflective display preferably works in a bistable memory state so that the display can work without continuous electronic signal input once a digital image signal is switched on. This also means that the power consumption can be virtually zero while a digital picture is displaying, or extremely low compared with other self-luminous displays. Energy is consumed only when the image is being changed. The feature of reflective display and bistable mechanism are of paramount importance for the use of the integrated digital picture viewing device. It is yet another object of the present invention that an anti-glare coating is coated on the viewing side of the digital picture viewing device to enhance the similarity of the display to printed or painted picture. It is further an object of the present invention to provide a digital picture viewing apparatus that both the image and audio message can be digitally controlled with the use of an electronically functional frame for easy playback with the programmed digital images and audio messages, and for easy in-situ audio message taken, as well as for easy retrieving of both image and audio files stored in a removable memory flash card or a stick.

Therefore, the picture itself in this invention is shown on a reflective bistable full color flat-panel display, including an interference modulator display (IMD), an electrochromic display (ECD) and an electrophoretic display (EPD), and preferably an IMD. The reflective flat panel display is preferably to be coated with an anti-glare coating on the viewing surface to reduce possible light glare on the display viewing side. The picture information originates digitally stored in a memory media and controlled by a central process unit (CPU) or desirably by a micro-processor similar to the one inside a digital camera, and in fact could be any digitized signal process system. The electronic control component and the digital memory storage are located in the picture frame as a cartridge form. To enhance picture display information, an image read-only component is desired and enclosed in the picture frame to receive pictures stored in a memory card or in a memory stick taken by a digital camera or by a digital camcorder.

When audio message playback is desired, a control system like a digital recording and playback system similar to the one inside a digital telephone set is desired and assembled inside the picture frame. In another aspect, a removable audio memory card or a recordable tape like the one in a mini voice recorder can be read through a read-record component inside the picture frame to present audio message or music according to need and situation.

The digital picture viewing apparatus is powered by either a battery system, or a solar battery system, or an AC converted DC source, preferably by a battery system and/or a solar battery system.

The picture control and audio control can be processed by pressing buttons on the front of the picture frame or on the edge of the picture frame. In another aspect, the control of picture image and audio can be linked and controlled by a computerized system, or by a remote controller like the one for TV channel and voice remote controller.

This brief summary has been provided so that the nature of the invention may be understood quickly. A more complete understanding of the invention can be obtained by reference to the following detailed description of the preferred embodiments and figures thereof in connection with the attached drawings.

### DESCRIPTION OF THE DRAWINGS

TABLE 1 is the comparison results of various reflective displays.

FIG. 1 is an illustration of IMD display with red, green and blue pixels and a non-glare coating on the viewing side.

FIG. 2 is an illustration of an embodiment of the integrated smart digital picture viewing device.

FIG. 3 is a diagram of an embodiment of the electronic control circuit for an integrated digital picture viewing device.

FIG. 4 is an embodiment diagram for the production of an integrated digital picture viewing device.

### DETAILED DESCRIPTION OF THE PREFERRED EMBODIMENT

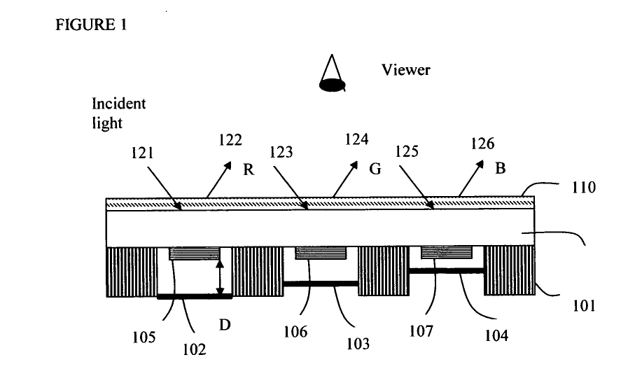

With reference to the TABLE 1 and drawings (FIG. 1-4), the preferred embodiments of the present invention will be described. Since human eye is evolved to see reflective light, a reflective image display is mostly suitable in this invention. To satisfy several requirements that can be best used for the disclosed smart digital picture viewing device, the following criteria are of most importance: 1). A flat panel display with vivid full color; 2). A reflective flat panel display with good reflectivity (reflectivity>60%); 3). A reflective flat panel display with a bistable memory working mechanism, meaning both image display state and non image display state are in a stable state.

From the comparison and analysis of various reflective flat panel displays as listed in TABLE 1, it is concluded that IMD, ECD and EPD have similarly excellent reflectivity and contrast ratio as book and better than newspaper and reflective LCD in general, and therefore they are selected as the reflective display panel in this invention as preferable embodiments.

In one embodiment of this invention the flat panel display screen is an interference modulator display (IMD). The IMD element uses light interference to create color in the same way that structural color works in nature. Microscopic structures on butterfly wings and peacock feathers cause light to interfere with itself, creating the shimmering iridescent colors that we see in these creatures. The IMD display works in the same way. A full color display element of IMD consists of a red, a green and a blue pixel display element as shown in FIG. 1. Each pixel is a simple MEMS (micro-electromechanical system) device that is composed of two conductive plates or electrodes. As shown in FIG. 1, one electrode is a thin film stack (such as 105, 106 or 107) on the substrate 100, such as aluminum film coated with silicon dioxide on a glass substrate, the other is a metallic membrane, such as a chromium mirror membrane suspended over it (such as 102, 103, or 104). There is a gap D between the two that is filled with air. Each pixel is separated and supported by photoresist poles 101. The IMD pixel has two stable states or bistable memory states. When no voltage is applied between the thin film stack and the metal membrane, the two electrodes are separated, and light hitting the substrate (such as incident light 121, 123 or 125) is reflected as shown to give reflective light 122, 124 or 126 for red, green or blue in FIG. 1. When a small voltage is applied, the plate electrodes are pulled together by electrostatic attraction and the light is absorbed, turning the element black. Pixel memory is crucial to producing a high quality display with minimal power consumption. IMD elements, which make up the IMD pixels, possess electro-mechanical memory called hysteresis. The hysteresis effect works somewhat like a pop-top on a bottle. Once the metallic membrane has been pulled down, it requires less energy to hold it than was exerted in pulling it down. This bi-stability not only allows the IMD display to replace the non-linearity of an active matrix device, it can also act as a real memory element. It consumes virtually zero energy in a still picture display state. Even with picture scrolling or in a movie state, it consumes considerably much less power than a LCD display. The colors are determined by the gap distance of the insulating poles (101 in FIG. 1) according to the formula D-nλ/2, as well as the height of the deformable membrane, wherein n is the numeral number (1, 2, 3, . . . ) and λ is wavelength of the reflective light. Thus, the gap D for red (with light wavelength of 628 nm) pixel can be 314 nm; the D for green (520 nm) pixel can be 260 nm; and D for blue (450 nm) pixel can be 225 nm. For a full color display, three pixel sets are fabricated with dimensions selected to allow red-black, green-black and blue-black switching respectively. The display pixels are minuscule, typically 25-300 microns on a side in this invention according to the requirement of display resolution. Arrays of many display pixels give a dot matrix display panel. Therefore, many IMD elements are ganged and driven together as a pixel, or sub-pixel in a color display. To create a flat panel display, a large array of IMD elements are fabricated in the desired format and packaged. Finally, driver chips are attached at the edge to complete the display. Suitable IMD display arrays and driver chips assemble heretofore described in the art as being useful of this purpose, including without limitation the process as described in M. W. Miles “Reflective displays using interferometric modulation” SID International Symposium Digest of Technical Papers, pp 32, (Long Beach, Calif., May 2000). It is obvious for anyone skilled in the art to understand the principle and construct the display accordingly.

In another embodiment of this invention the display screen is an electrochromic flat-panel display (ECD). An ECD element consists of two electrodes. One of the electrodes may be an electrochromically active thin film such as a conjugated polymer like poly(hexyl thiophene) or a thin layer of tungsten oxide which is usually coated on a transparent conducting glass, like indium tin oxide coated glass (ITO glass).

Another electrode is an electrochemically stable metal, such as nickel metal sheet with smooth surface to serve as a mirror as well. Under an electronic signal injection, the electrode film is electronically oxidized or reduced, and so that the display element film changes its color, for instance from transparent to red; the red color can be maintained even without power once the picture pattern is generated. Under a reversed electron signal, the red film can be reversibly backed to its original state, i.e. transparent. Similarly, green and blue bistable color display can also be achieved by employing different thin film materials. ECD has advantage of high reflectivity, excellent contrast ratio together with the fast switching, low power consumption and low voltage operation features. In addition it is a bi-stable structure so power is only required for image updating, allowing reduced power consumption, and display cells can be driven from 1-2 volts. Suitable ECD display arrays and driver chips assemble heretofore described in the art as being useful of this purpose, including without limitation the process as described in M. Vasilopoulou, et al, “Fabrication of WO₃ based electrochromic displays using solid or gel-like organic electrolytes” J. Phys., 10, 329 (2005). It is obvious for anyone skilled in the art to understand the principle and construct the display accordingly.

Yet another bistable reflective flat-panel display suitable in this invention is called electrophoretic flat panel display (EPD). The principal components of electrophoresis display are millions of tiny microcapsules, about the diameter of a human hair. In one incarnation, each microcapsule contains positively charged white particles and negatively charged black (or color red, green or blue) particles suspended in a clear fluid. When a negative electric field is applied, the white particles move to the top of the microcapsule where they become visible to the user. This makes the surface appear white at that spot. At the same time, an opposite electric field pulls the black (or red, or green or blue) particles to the bottom of the microcapsules where they are hidden. By reversing this process, the black (or red, green or blue) particles appear at the top of the capsule, which now makes the surface appear dark (or color) at that spot. Therefore, electrophoresis is a reflective and bistable display technology. It consumes virtually zero energy in a still picture display state. Even with picture scrolling or in a movie state, it consumes considerably much less power than full color backlit LCD display. The use of electrophoresis as the basis of a display transducer was first described in U.S. Pat. No. 3,612,758 (by PF Evans, et al, “Color display device” and in U.S. Pat. No. 3,668,106 (by I. Ota, “Electrophoretic display device”). It has the advantages of bistability, low power requirements, good viewing angles, and fast response time. Its basic display element is built with two electrodes (such as one with Ni metal and another with indium tin oxide coated glass substrate as viewing side) sandwiched with colored ink particles suspended in an organic fluid. Suitable EPD display arrays and driver chips assemble heretofore described in the art as being useful of this purpose, including without limitation the process as described in S A Swanson, et al “High performance electrophoretic displays” SID International Symposium Digest of Technical Papers, pp 29, (Long Beach, Calif., May 2000). It is obvious for anyone skilled in the art to understand the principle and construct the display accordingly.

To make an integrated digital picture viewing device resemble naturally printed or painted pictures on paper or on fabrics, a non-glare coating is necessary to coat on the surface of the display glass substrate so that ambient light is scattered and diffused, thereby further reducing glare. A very practical consideration for coatings applied to the smart digital picture viewing device is that the glare-reducing coating should adhere to the glass surface, and should be sufficiently hard to resist abrasion and chemically resistant to moisture, humidity and common household cleaning solutions. The coating thickness is normally between 50 nm to 1000 nm, and preferably 100 nm-500 nm. There are many commercially available non-glare coatings suitable for this purpose of application. Therefore the coating 110 in FIG. 1 can be selected from an aqueous solution of an alkali silicate, Ti(OEt).sub.4 or Ta(OEt).sub.5, or another metal alkoxide such as Si(OET).sub.4, treated with HCl acid to form cross linking coatings. However, the invention is not limited to the use of these materials.

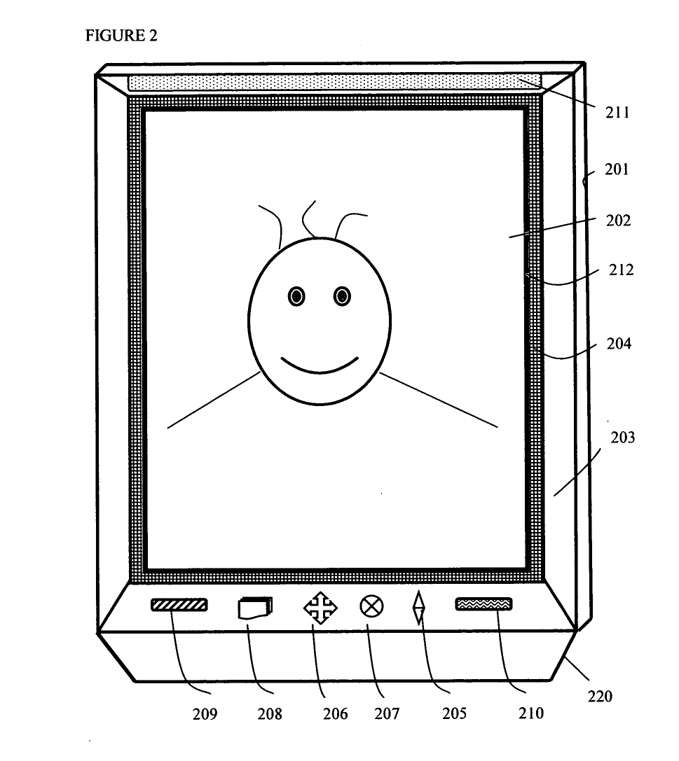

FIG. 2 shows an integrated digital picture viewing device 201. It generally comprises a bistable reflective flat panel display 202 with the size of diagonal 21 inches or larger according to need, which is physically affixed to or contained with or without adhesive in frame 203. Attached on the frame, an optional lid cover for the electronics control board 220 is illustrated. The reflective flat panel display means non-emission display with a slim feature and with the thickness of the display less than 2 inches. It generally has a viewing side, a backside and a non-glare coating on the viewing side. The displayed image is therefore viewed only under lit condition by light reflection mainly and partially by light diffraction. The reflective flat panel display is a reflective bistable memory display so that both image display state and non image state are in a stable state and therefore consumes virtually zero power. When a digital image is once updated, the image picture is generated and remained even without continuous signal input. Suitable bistable reflective flat panel displays that are mostly suitable in this invention include IMD, ECD and EPD.

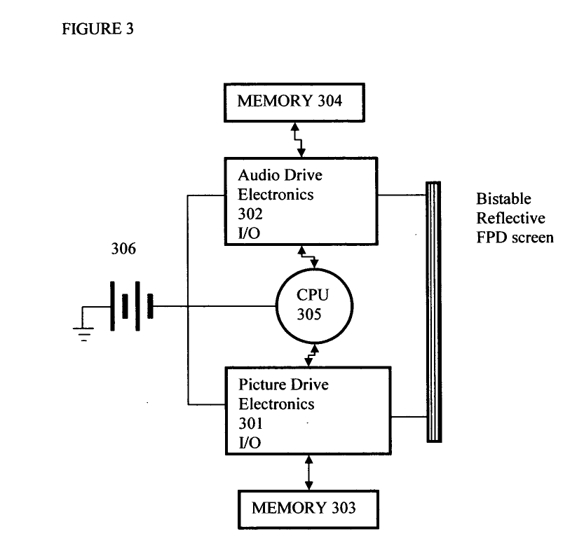

The digital picture viewing frame generally comprises a picture or video electronics drive 301 (FIG. 3) for processing image digital files, at least a memory device (303) for storing video or image digital information, a central process unit (CPU) (305) for integration and control, a power source (306) to provide electricity. All these parts are in a form of cartridge shape and are readily assembled inside the frame 203. The electronic integration of the key parts is illustrated in FIG. 3 in one embodiment for this invention with control switches.

To enhance the digital smart picture display with audio message or music broadcasting functions, an audio drive electronics 302 with programmed audio signal process and recording functions is used, alternatively an audio memory 304 is present to read removable audio digital files stored in a flash card through the audio port 304 I/O. A speaker (204) surrounded around the reflective display is desirably used for voice and music delivering. The integration of 302, 304 and 305 can be a similar technology in a simple digital telephone set.

For the purpose of effective control, a switch of audio/video button 205 is preferred; there are other functional buttons and controls, such as a menu button 208 to select various functions such as picture selection, music selection, combination of various pictures etc; a forward/backward scroll switch 206; a record function button 207 for voice recording. For retrieving digital picture files or audio files, two slots respectively for reading digital image slot 210 and audio slot 209 are employed to read storage memory stick or flash card. All these control buttons can alternatively be located on a remote controller.

Although a AC power source can be used in this invention, a battery or a set of batteries is preferably used, and mostly desirably a solar cell 211 as shown in FIG. 2 is used since the digital picture viewing device consumes considerably much less power than any of luminous display panels so far.

The smart digital picture viewing device can display satisfied image under room lit condition. In case of pitch dark condition, a white light source is suggested, and preferably a surface thin film lighting source is used as a lighting ribbon 212 (FIG. 2). To serve this purpose, an electroluminescent (EL) ribbon or an organic light emitting device (OLED) can be used. Most preferably a white OLED using phosphorescent dopants as described in B W Andrade is used (“Controlling exciton diffusion in multilayer white phosphorescent organic light emitting devices” Adv. Mater., 2, pp 147 (2002)), wherein iridium organometallic complexes with red, green and blue emission are used as active dopants and they are sandwiched between an ITO glass transparent electrode and aluminum mirror electrode. However, the invention is not limited to the use of these materials.

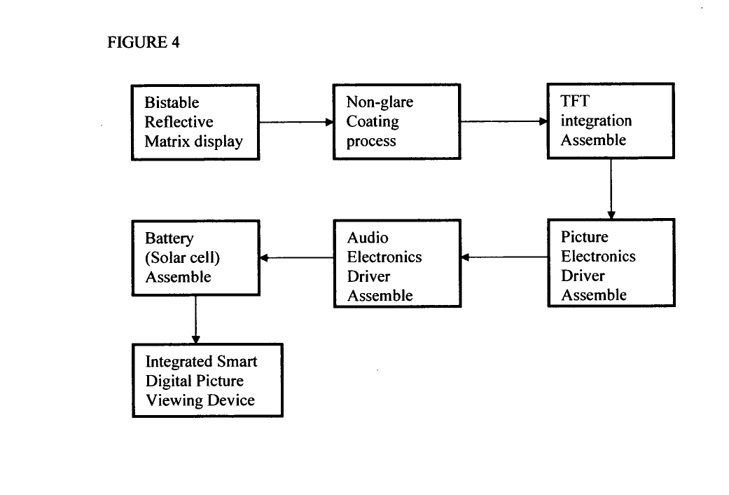

A reflective flat-panel display as disclosed in this invention means an electronic display flat panel screen which has a backside and viewing side. The backside is integrally coupled to the frame of the smart digital viewing apparatus, electrically coupled with a power source, electronically coupled with an image/audio control assemble through a central process unit (CPU) or a micro processor. The viewing side contains transparent layers such as a thin glass substrate, thin polymer film, and other coatings that effectively reducing glare, enhancing hardness to prevent scratching etc. The reflective flat panel display means non-emission display with a slim feature and with the thickness of the display less than 2 inches. The displayed image is therefore viewed only under lit condition by light reflection mainly and partially by light diffraction. The reflective flat panel display is preferred a reflective bistable memory display so that both image display state and non image state are in a stable state and therefore consumes virtually zero power at each state. When a digital image is once updated, the image picture is generated and remained even without continuous signal input. The manufacture of an integrated digital picture viewing device therefore can be summarized as major 6 steps or process flows as shown in FIG. 4.

While the present invention has been described in terms of preferred and alternative embodiment, it will be obvious to one skilled in the art that many alternations and modifications may be made without substantially departing from the spirit of the invention. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

I claim:
TABL 1
Comparison of Various Reflective Displays

| | Reflectivity (%) | Contrast Ratio | Coloration |
|---|---|---|---|
| Book | 80 | 9 | Good |
| Newspaper | 67 | 5 | Good |
| TN-LCD | 15 | 4 | Weak |
| Ch-LCD | 37 | 5 | Good |
| EPD | 80 | 12 | Good |
| ECD | 65 | 8 | Good |
| IMD | 70 | 12 | Good |

1. An integrated smart digital picture viewing device comprising:
a). A full color flat panel display with a diagonal size of 4-60″ inches and thickness less than 2 inches to display a plurality of still digital images having a viewing side, a backside and a non-glare coating on the viewing side; said flat panel display is a reflective display with bi-stability characteristics and constructed without using liquid crystal material;
b). A picture frame wherein a CPU and programmed digital pictures and digital picture reading device are stored and controlled by an image electronics drive component in a cartridge form;
c). A picture frame wherein audio message is programmed and controlled digitally by a CPU; and a digital audio reading/recording device is stored and controlled by an audio electronics drive component in a cartridge form;
d). A picture frame with a speaker for broadcasting voice message or music surrounded around the display module;
e). A picture frame with a power source attached.

2. An integrated smart digital picture device as described in claim 1 wherein the reflective flat panel display is an electrophoresis display (EPD).

3. A smart digital picture device as described in acclaim 1 wherein the reflective display is an interference modulation display (IMD).

4. A smart digital picture device as described in claim 1 wherein the reflective flat panel display is an electrochromic display (ECD).

5. A smart digital picture viewing device as described in claim 1 wherein all the control buttons are located on a remote controller.

6. A smart digital picture viewing device as described in claim 1, 2, 3, and 4 wherein the power source is a set of batteries, and preferably a set of photovoltaic cells assembled on the device frame.

7. A smart digital picture viewing device as described in claim 1, 2, 3 and 4 wherein a surface electroluminescent lighting device is on the picture frame for extra lighting when in need, and preferably it is an organic-light-emitting device based surface lighting.

8. A digital picture frame for displaying still digital picture and for playing and recording voice message associated with the displayed picture, comprising:
a full color flat panel display with a diagonal size of 4-60″ inches and thickness less than 2 inches to display a plurality of still digital images having a viewing side, a backside and a non-glare coating on the viewing side; said flat panel display is a reflective display with bi-stability characteristics and constructed without using liquid crystal material;
A cartridge video electronics drive for retrieving digital image files from stored files;
A cartridge audio electronics drive for retrieving and/or recording voice message files;
A memory device for storing programmed video and audio files;
A central process unit (CPU) or a microprocessor to control the display picture or to control voice message;
A speaker surrounded around the display module;
A power source.

9. A smart digital picture frame as described in claim 8 wherein the power source is a set of batteries preferably a set of photovoltaic cells attached on the surface of the picture frame.

10. A smart digital picture frame as described in claim 8, 9 wherein an organic light-emitting device based surface lighting source is attached on the frame for extra lighting.

11. A digital picture frame for displaying still digital picture and for playing and recording voice message associated with the displayed picture as claimed in claim 8 wherein all the control buttons are on a remote controller.
